(19) United States
(12) Patent Application Publication
(10) Pub. No.: US 2013/0181966 A1
(43) Pub. Date: Jul. 18, 2013

(54) DISPLAY DRIVE CHIP INCLUDING EXTERNAL WIRING AND DISPLAY DEVICE

(71) Applicant: Samsung Electronics Co., Ltd., Suwon-si (KR)

(72) Inventors: Eui-Hyuk Jeong, Seongnam-si (KR); Hae-woon Park, Yangpyeong-gun (KR)

(73) Assignee: Samsung Electronics Co., Ltd., Suwon-si (KR)

(21) Appl. No.: 13/739,703

(22) Filed: Jan. 11, 2013

(30) Foreign Application Priority Data
Jan. 13, 2012 (KR) 10-2012-0004509

(51) Int. Cl. G09G 1/00

(52) U.S. Cl. CPC G09G 1/005
USPC 345/211

(57) ABSTRACT

A display drive chip and a display device including the same are disclosed. The display drive chip can include a first voltage generating unit outputting a power voltage and a second voltage generating unit outputting the power voltage. A circuit block can receive the power voltage; and a plurality of pads can be connected to internal pads of the power voltage, wherein the display drive has a layout structure in which at least two pads from among the plurality of pads are connected to the first voltage generating unit and the second voltage generating unit, respectively, and the plurality of pads can be connected to each other through external wiring.

### CROSS-REFERENCE TO RELATED APPLICATIONS

This application claims the benefit of Korean Patent Application No. 10-2012-0004509, filed on Jan. 13, 2012, in the Korean Intellectual Property Office, the disclosure of which is incorporated herein in its entirety by reference.

### BACKGROUND

The inventive concept relates to a display drive chip and a display device, and more particularly, to a display drive chip that reduces IR drop and a display device including the display drive chip.

Recently, there has been a need for display apparatuses having a screen capable of displaying high-quality moving pictures due to a variety of functions of applications of electronic products. As circuits become more complex due to the addition of a variety of functions to a display driving circuit, a layout area of the display driving circuit may be increased and the current consumption of the display driving circuit may also increase. When a layout area of a display driving circuit is increased and current consumption of the display driving circuit is increased, it is difficult to maintain the power voltage at a constant level to an entire region of the display driving circuit due to a drop in line voltage (IR drop) of the power voltage.

### SUMMARY

The inventive concept provides a display drive chip that may reduce a drop in power voltage without increasing an area of a display drive chip or increasing the number of layers for wiring, and a display device including the display drive chip.

In some embodiments according to the inventive concept, there is provided a display drive chip including a first voltage generating unit outputting a power voltage and a second voltage generating unit outputting the power voltage. A circuit block can receive the power voltage and a plurality of pads can be connected to internal wiring of the power voltage, wherein the display drive chip has a layout structure in which at least two pads from among the plurality of pads are connected to the first voltage generating unit and the second voltage generating unit, respectively, and the plurality of pads are connected to each other through external wiring.

The at least two pads may be spaced apart from each other by a predetermined interval in a layout.

The display drive chip may further include at least one bump, wherein the at least one bump may be connected to the plurality of pads through external wiring and may have a layout structure positioned in the circuit block.

At least one pad from among the plurality of pads may be positioned on an output stage.

At least two pads may be connected to capacitors, respectively.

The first voltage generating unit and the second voltage generating unit may receive a voltage from an external source and generate the power voltage.

The first voltage generating unit may include a bias generating unit and a first output stage, and the second voltage generating unit may include a second output stage, and a control voltage output from the bias generating unit may be applied to the first output stage and the second output stage.

The circuit block may have a layout structure in which a horizontal length is greater than a vertical length.

The display drive chip may be a mobile display drive chip on a mobile device, and the circuit block may be one of a plurality of driving modules in the display drive chip.

The display drive chip may be installed on a glass substrate of a display device, and the external wiring may be wiring formed on the glass substrate.

The wiring formed on the glass substrate may be indium tin oxide (ITO) wiring.

In some embodiments according to the inventive concept, there is provided a display device including a display panel and a display drive chip for driving the display panel. A connection portion can connect the display panel and the display drive chip to each other. The display drive chip can include a first voltage generating unit outputting a power voltage and a second voltage generating unit outputting the power voltage. A circuit block can receive the power voltage and a plurality of pads can be connected to internal wiring of the power voltage and at least one bump. At least one pad from among the plurality of pads can be internally connected to the wiring of the power voltage and can be externally connected to each other through wiring formed on the connection portion.

The connection portion may be a glass substrate, and the display drive chip may be installed on the glass substrate by using a chip on glass (COG) method.

The display device may further include a touch panel and a touch controller.

The display panel may be a liquid crystal display (LCD) panel.

In some embodiments according to the inventive concept, a display device can include a display device substrate and a display drive chip that can include a plurality of internally spaced apart voltage generating units providing respective power voltages configured for operation of the display drive chip. The respective power voltages can be distributed within the display drive chip via internal wiring inside the display drive chip and a plurality of pads can be on an exterior of the display drive chip, and can be coupled to the internal wiring. External wiring can be outside the display drive chip and coupled to the plurality of pads.

In some embodiments according to the inventive concept, the plurality of pads can be a plurality of input pads spaced apart along a first edge of the display drive chip. In some embodiments according to the inventive concept, the display device can further include a bump, on the display drive chip that can be spaced apart from the plurality of input pads, and can be configured to electrically connect the internal wiring within a logic circuit region of the display drive chip to the external wiring, where the logic circuit region can be located in a central region of the display drive chip.

In some embodiments according to the inventive concept, the internal wiring is narrower than the external wiring.

In some embodiments according to the inventive concept, the external wiring provides a lower resistance path for the respective power voltages to the logic circuit region.

In some embodiments according to the inventive concept, the bump comprises a plurality of spaced apart bumps on the display drive chip, each configured to electrically connect the internal wiring within a respective region of the display drive chip to the external wiring.

In some embodiments according to the inventive concept, the plurality of pads can include input pads along a first edge of the display drive chip, and the display device can further include an internal source driver circuit, inside the display drive chip, that can be configured to drive signals to the display device. A plurality of output pads, can be on the exterior of the display drive chip along a second edge of the display drive chip, and can be coupled to the internal wiring within the internal source driver circuit.

In some embodiments according to the inventive concept, the display device can further include a bump, on the display drive chip that is spaced apart from the plurality of output pads, and can be configured to electrically connect the internal wiring within the internal source driver circuit of the display drive chip to the external wiring, wherein the internal source driver circuit is located directly adjacent to the plurality of output pads.

### BRIEF DESCRIPTION OF THE DRAWINGS

Exemplary embodiments of the inventive concept will be more clearly understood from the following detailed description taken in conjunction with the accompanying drawings in which:

FIG. 1 is a diagram showing a display drive chip according to an embodiment of the inventive concept;

FIG. 2 is a diagram showing a drop in line voltage within a chip;

FIG. 3 is a cross-sectional view of the display drive chip of FIG. 1, according to an embodiment of the inventive concept;

FIGS. 4A through 4E are diagrams for describing display drive chips provided by modifying pads and external wiring of the display drive chip of FIG. 1, according to various embodiments of the inventive concept;

FIG. 5 is a floor plan view of the display drive chip of FIG. 1, according to an embodiment of the inventive concept;

FIG. 6 is a block diagram of first and second voltage generating units of the display drive chip of FIG. 5, according to an embodiment of the inventive concept;

FIG. 7 is a floor plan view of the display drive chip of FIG. 1, according to another embodiment of the inventive concept;

FIG. 8 is a block diagram of first and second voltage generating units of the display drive chip of FIG. 7, according to another embodiment of the inventive concept;

FIG. 9 is a floor plan view of the display drive chip of FIG. 1, according to another embodiment of the inventive concept;

FIG. 10 is a diagram illustrating a display device mounted on a glass substrate, according to an embodiment of the inventive concept;

FIG. 11 is a perspective view of a display device according to an embodiment of the inventive concept; and

FIG. 12 shows applications of various electronic products including a display device installed thereon, according to an embodiment of the inventive concept.

### DETAILED DESCRIPTION OF THE EMBODIMENTS ACCORDING TO THE INVENTIVE CONCEPT

The inventive concept will now be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the concept of the inventive concept to those of ordinary skill in the art. In the drawings, the thicknesses of layers and regions are exaggerated for clarity.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

It will be understood that when an element is referred to as being “connected” or “coupled” to another element, it can be directly connected or coupled to the other element or intervening elements may be present. As used herein, the term “and/or” includes any and all combinations of one or more of the associated listed items. The terminology used herein is for the purpose of describing particular embodiments only and is not intended to be limiting of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

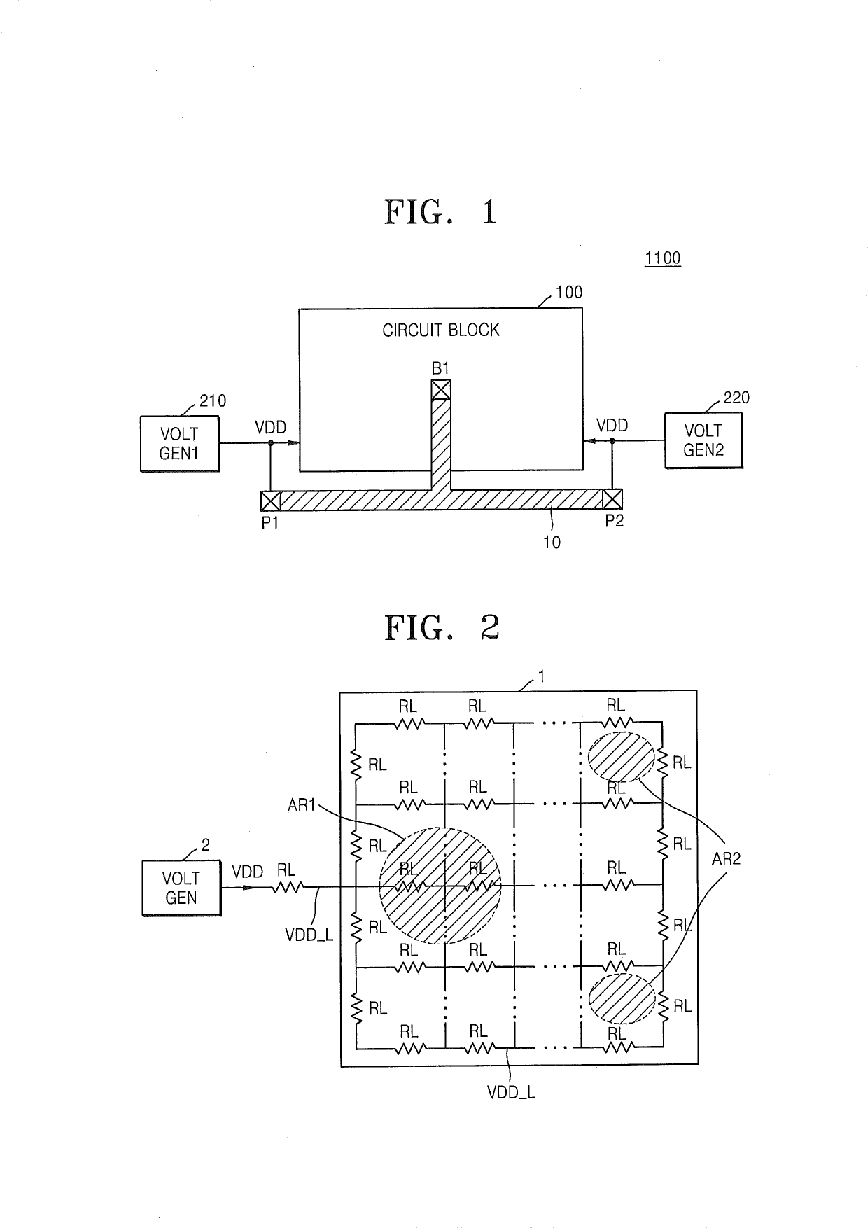

FIG. 1 is a diagram showing a display drive chip 1100 according to an embodiment of the inventive concept.

Referring to FIG. 1, the display drive chip 1100 may include a circuit block 100, a plurality of voltage generating units 210 and 220, a plurality of pads P1 and P2, and at least one bump B1. The pads P1 and P2 and the bump B1 may be electrically connected to each other through external wiring 10. In FIG. 1, two pads P1 and P2 and a single bump B1 are shown. The number of pads and bumps are not limited thereto and may be changed in various forms according to a layout area of the display drive chip 1100.

The circuit block 100 receives an image signal applied from an external source and generates a driving signal to be applied to a display panel. For example, the circuit block 100 may be a logic circuit for generating a control signal that is applied to a source driver, a gate driver, a graphic random access memory (GRAM), or other circuits. The logic circuit may be a timing controller.

The voltage generating units 210 and 220 generate and output a power voltage VDD of the circuit block 100. The voltage generating units 210 and 220 may include a first voltage generating unit 210 and a second voltage generating unit 220. The first voltage generating unit 210 and the second voltage generating unit 220 generate and output the power voltage VDD of the circuit block 100 by using a voltage applied from outside of the display drive chip 1100 or a voltage generated from another voltage generating unit (not shown) included in the display drive chip 1100. The display drive chip 1100 of FIG. 1 includes the two voltage generating units 210 and 220 but the inventive concept is not limited thereto. The number of voltage generating units may be changed in various forms.

The pads P1 and P2 may be an input pad for receiving external signals or voltages or a output pad for outputting internally generated signals or voltage to outside of the display drive chip 1100. The bump B1 may be a connection for connecting external signals to the internal circuits of the display drive chip 1100. The pads P1 and P2 may be respectively connected to output terminals of the voltage generating units 210 and 220 internally, and for example, the pads P1 and P2 may be respectively connected to output terminals of the voltage generating units 210 and 220 through internal wiring such as a metal line. The bump B1 may be internally connected to wiring of the power voltage VDD, which is disposed in a central portion of the circuit block 100. In addition, the pads P1 and P2 and the bump B1 may be electrically connected to each other through the external wiring 10. Since the pads P1 and P2 and the bump B1 are connected through external wiring, line resistance of the power voltage VDD may be reduced without increasing a layout area of the display drive chip 1100.

As described above, since the power voltage VDD is applied via two sides of the circuit block 100 by the voltage generating units 210 and 220 and also the power voltage VDD is applied to the circuit block 100 through the pads P1 and P2, the bump B1 and external wirings, a drop in line voltage (IR drop) of the power voltage VDD applied to the circuit block 100 may be reduced.

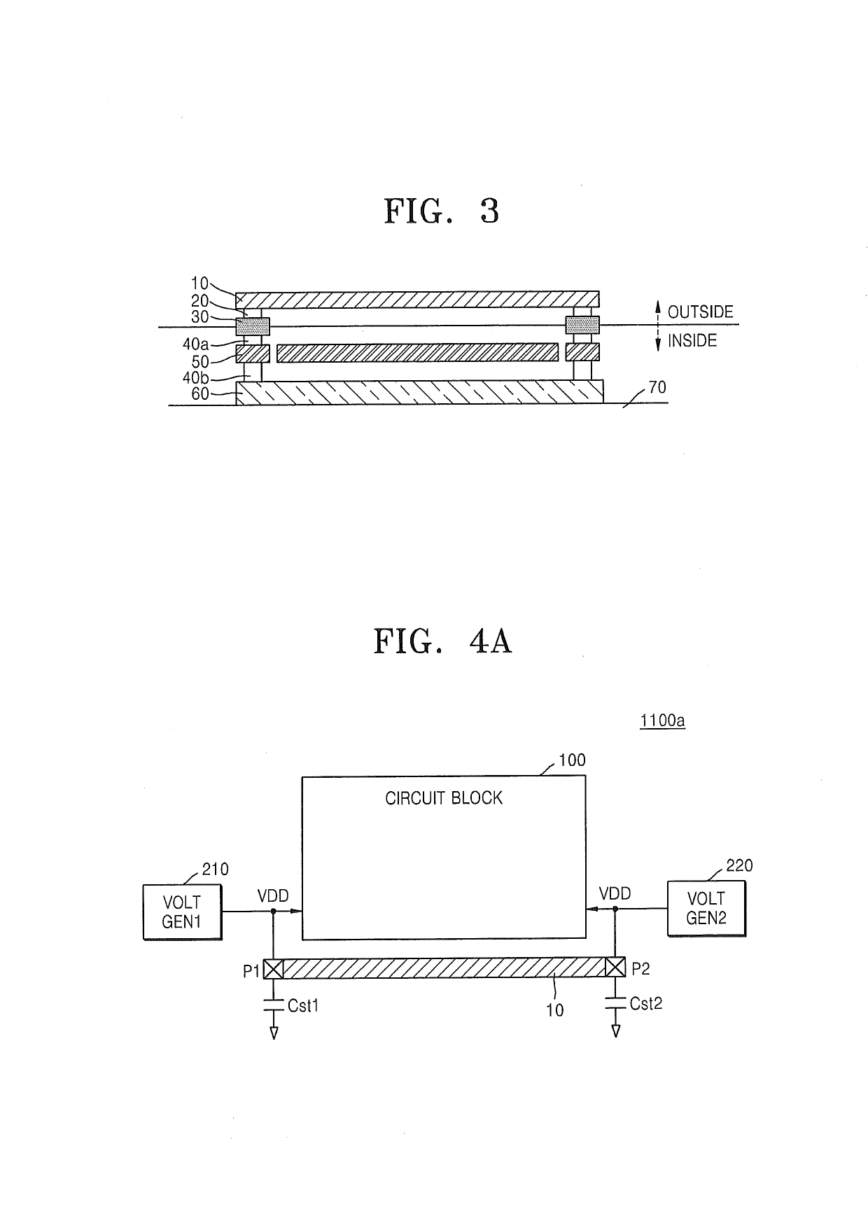

Hereinafter, a drop in line voltage (IR drop) will be described with reference to FIG. 2.

FIG. 2 is a diagram for describing a drop in line voltage (IR drop).

Referring to FIG. 2, a voltage generating unit 2 generates power voltage VDD and applies the power voltage VDD to a circuit block 1. Since the circuit block 1 receives the power voltage VDD and operates, power voltage wirings VDD_L are connected to each other in the circuit block 1. Since the power voltage wirings VDD_L have resistive components, wiring resistors RL corresponding to the resistive components exist. Thus, the drop in line voltage (IR drop) occurs due to current delivered to the circuit block 1 via the wiring resistors RL.

As appreciated by the present inventors, due to the drop in line voltage (IR drop), the power voltage VDD that is lower than in a region AR1 adjacent to the voltage generating unit 2 may be applied to a region AR2 that is farther from the voltage generating unit 2, in the circuit block 1. If the power voltage VDD having a predetermined voltage level or less is applied, the circuit block 1 may malfunction. To prevent this, resistance of the power voltage wirings VDD_L applied to an entire region of the circuit block 1 can be reduced. The resistance may be reduced by reducing the lengths of wirings of the line resistors RLs and increasing the width of the wirings.

Referring back to FIG. 1, the first voltage generating unit 210 and the second voltage generating unit 220 are spaced apart from each other and may apply the power voltage VDD to both right and left sides of the circuit block 100. Thus, the lengths of wirings of the power voltage VDD applied to the circuit block 100 may be reduced. In addition, the resistance of wirings of the power voltage VDD may be reduced by electrically connecting the bump B1 and the pads P1 and P2 connected to the wirings of the power voltage VDD to each other through external wirings. Thus, the power voltage VDD with a constant voltage level may be applied to an entire region of the circuit block 100.

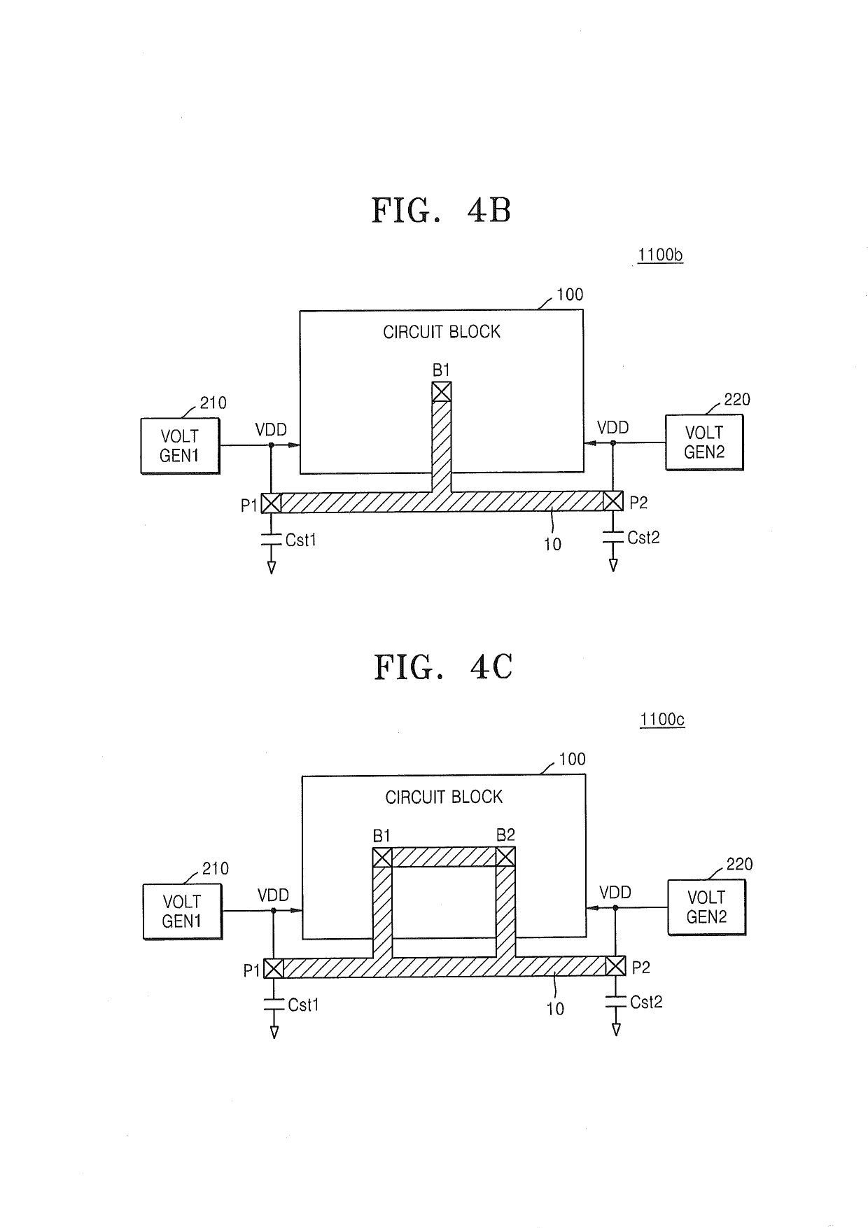

FIG. 3 is a cross-sectional view for describing a case where the pads P1 and P2 of the display drive chip 1100 of FIG. 1 are connected to each other through external wiring in the display drive chip 1100 of FIG. 1, according to an embodiment of the inventive concept.

Referring to FIG. 3, a core layer 60, a metal layer 50, and a bump layer 30 may be sequentially formed on a semiconductor substrate 70, in the display drive chip 1100. The core layer 60, the metal layer 50, and the bump layer 30 may be electrically connected to each other through contact portions 40a and 40b. For convenience of description, FIG. 3 shows a single metal layer 50 being used. However, various types of metal layers may be used.

The external wiring 10 is formed outside the display drive chip 1100. The external wiring 10 may be electrically connected to the metal layer 50 through contact portions 20 and 40a and the bump layer 30.

Internal devices of a circuit, such as a transistor, a capacitor, a resistor, or the like may be formed on the core layer 60. The internal devices formed on the core layer 60 may be electrically connected to each other through wirings and the contact portion 40b formed on the metal layer 50. In addition, power voltage wiring, a control signal line and pad, and the like may be formed as the metal layer 50. Connection terminals for connecting internal wiring of the display drive chip 1100 to external wiring of the display drive chip 1100 may be formed on the bump layer 30.

Referring to FIGS. 1 and 3, wiring of the power voltage VDD of FIG. 1 is formed as the metal layer 50. In addition, the pads P1 and P2 may be formed as the metal layer 50 and the bump layer 30. The bump B1 may be formed as the bump layer 30 on the wiring of the power voltage VDD. The pads P1 and P2 and the bump B1 are connected to each other through the external wiring 10 and are internally connected to the circuit block 100 formed on the core layer 60 or the first voltage generating unit 210 and the second voltage generating unit 220 through the metal layer 50.

In FIG. 1, as appreciated by the present inventors when the width of the wiring of the power voltage VDD on the metal layer 50 is increased in order to reinforce the wiring of the power voltage VDD, a layout area of the display drive chip 1100 may be increased. In addition, if a metal layer is added during a manufacture process, manufacturing costs may be increased. However, as shown in FIG. 3, when the power voltage VDD is applied through the external wiring 10, since the width of wiring of the metal layer 50, as wiring of the power voltage VDD, does not have to be increased in the display drive chip 1100, a layout area may be reduced relative to conventional approaches.

When the display drive chip 1100 is mounted on a glass substrate or the like, the external wiring 10 may be indium tin oxide (ITO) wiring formed on the glass substrate. Since wiring of the power voltage VDD may be reinforced by using the ITO wiring used to transmit driving signals between the display drive chip 1100 and a display panel, manufacturing costs may not be increased. Alternatively, the display drive chip 1100 may be mounted on a different type of substrate and the type of external wiring 10 may be changed in various forms.

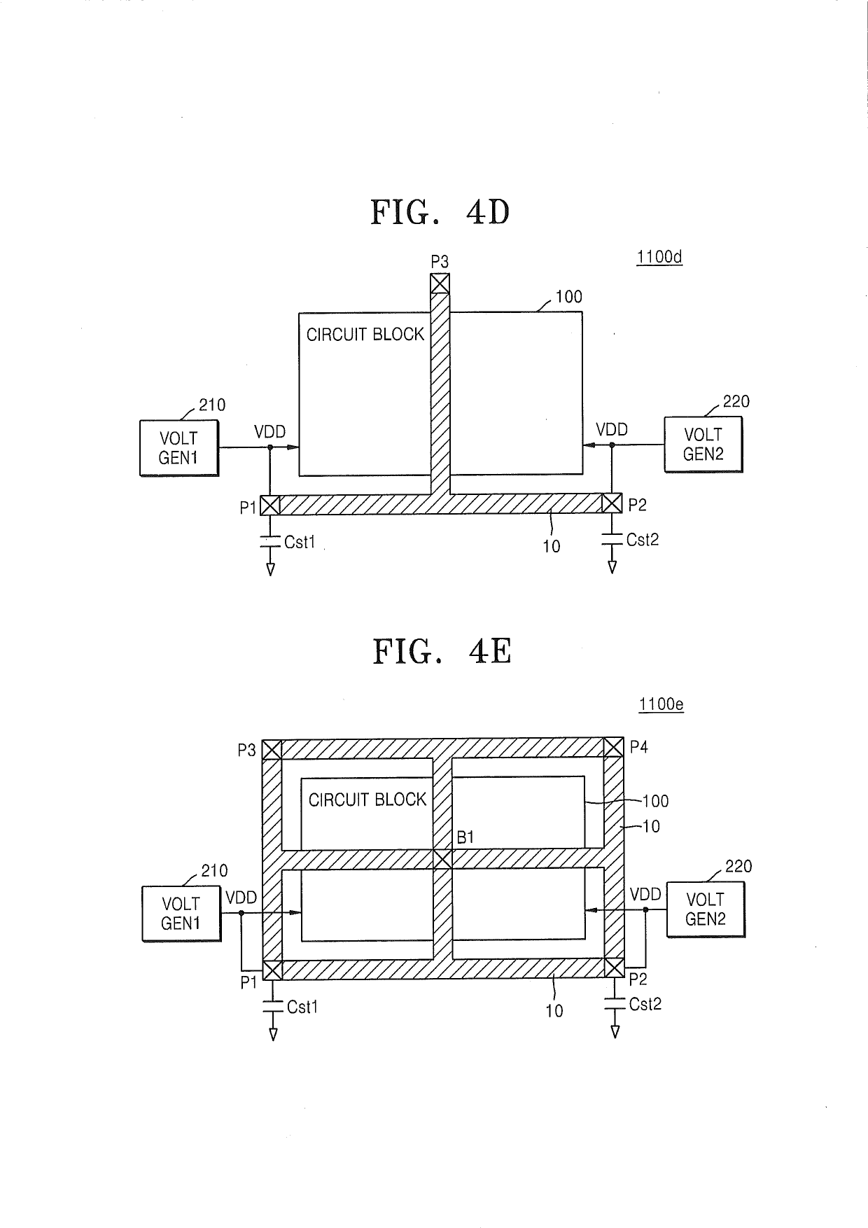

FIGS. 4A through 4E are diagrams for describing display drive chips 1100a, 1100b, 1100c, 1100d, and 1100e obtained by modifying the pads P1 and P2 and the external wiring 10 of the display drive chip 1100 of FIG. 1, according to various embodiments of the inventive concept.

Referring to FIG. 4A, the display drive chip 1100a may include the circuit block 100, the voltage generating units 210 and 220, and a plurality of pads P1 and P2. In addition, storage capacitors Cst1 and Cst2 may be installed outside the display drive chip 1100a. The circuit block 100, the voltage generating units 210 and 220, and the pads P1 and P2 are the same as in FIG. 1, and thus, detailed descriptions thereof will not be repeated here.

In FIG. 4A, the first pad P1 and the second pad P2 may be output pads positioned on an input stage of the display drive chip 1100a. The first pad P1 and the second pad P2 may output the power voltage VDD output from the voltage generating units 210 and 220 to the outside. The first voltage generating unit 210 and the second voltage generating unit 220, and a first storage capacitor Cst1 and a second storage capacitor Cst2 are connected to each other through the first pad P1 and the second pad P2, respectively. The first and second the storage capacitors Cst1 and Cst2 may be charged with the power voltage VDD.

The storage capacitors Cst1 and Cst2 may maintain the power voltage VDD generated by the first and second voltage generating units 210 and 220 at a stable voltage level. For example, when a noise signal is applied to the first and second voltage generating units 210 and 220 or outside of the first and second voltage generating units 210 and 220, the storage capacitors Cst1 and Cst2 may prevent a voltage level of the power voltage VDD from being changed due to the noise signal. In addition, when a large amount of current is momentarily consumed in the circuit block 100, the storage capacitors Cst1 and Cst2 as well as the first and second voltage generating units 210 and 220 may supply current to reduce the driving burden of the first and second voltage generating units 210 and 220, thereby reducing a drop in the power voltage VDD. The storage capacitors Cst1 and Cst2 may each have capacity of about 1 uF to about 2 uF but are not limited thereto. Capacity of the storage capacitors Cst1 and Cst2 may be determined in consideration of current consumption of the circuit block 100. In FIG. 1, the storage capacitors Cst1 and Cst2 are installed outside the display drive chip 1100. However, the inventive concept is not limited thereto. Thus, the storage capacitors Cst1 and Cst2 may be installed outside or inside the display drive chip 1100 according to a capacity of the storage capacitors Cst1 and Cst2.

Referring to FIG. 4A, the display drive chip 1100a includes the first voltage generating unit 210 and the second voltage generating unit 220, for generating the power voltage VDD of the circuit block 100. In a layout, the first and second voltage generating units 210 and 220 are spaced apart from each other by a predetermined interval and are disposed at right and left sides of the circuit block 100. Thus, the power voltage VDD with a constant level may be applied to the right and left sides of the circuit block 100. In addition, since the pads P1 and P2 are connected to each other through external wiring of the display drive chip 1100a, when asymmetric current consumption is generated at the right and left sides of the circuit block 100, the first voltage generating unit 210 and the second voltage generating unit 220 may complementarily supply current.

Referring to FIG. 4B, the display drive chip 1100b may include the circuit block 100, the voltage generating units 210 and 220, the pads P1 and P2, and the bump B1. The storage capacitors Cst1 and Cst2 may be installed outside the display drive chip 1100b. Comparing with the display drive chip 1100a of FIG. 4A, the display drive chip 1100b may further include the bump B1 that is positioned inside the circuit block 100 in a layout. The bump B1 is connected to the first pad P1 and the second pad P2 through external wiring and is internally connected to wiring of the power voltage VDD, which is disposed in a central portion of the circuit block 100. Thus, line resistance of wiring of the power voltage VDD between the first and second voltage generating units 210 and 220 and the central portion of the circuit block 100 may be reduced.

Referring to FIG. 4C, the display drive chip 1100c may include the circuit block 100, the voltage generating units 210 and 220, the pads P1 and P2, and a plurality of bumps B1 and B2. In addition, the storage capacitors Cst1 and Cst2 may be installed outside the display drive chip 1100c. When a horizontal length, that is, a width of the circuit block 100, is long in a layout, two bumps or more, that is, the bumps B1 and B2 are positioned in the circuit block 100 and the pads P1 and P2 and the bumps B1 and B2 are electrically connected through external wirings. Thus, a drop in the power voltage VDD due to a drop in line voltage (IR drop) may be minimized and the power voltage VDD with a constant voltage level may be applied to an entire region of the circuit block 100.

Referring to FIG. 4D, the display drive chip 1100d may include the circuit block 100, the voltage generating units 210 and 220, and a plurality of pads P1, P2, and P3. In addition, the storage capacitors Cst1 and Cst2 may be installed outside the display drive chip 1100d.

A third pad P3 may be a dummy output pad that is positioned on an output stage of the display drive chip 1100d. In a layout, output pads for outputting a driving or control signal applied to a display panel are positioned on the output stage of the display drive chip 1100d. A dummy output pad that does not output any signal or voltage may be positioned between the output pads. One of the dummy output pads is set as the third pad P3 and is connected to wiring of the power voltage VDD, which is positioned on an upper end portion of the circuit block 100 in a layout through internal wiring. In addition, the third pad P3, the first pad P1, and the second pad P2 are electrically connected to each other through external wirings. Thus, the power voltage VDD with a uniform potential may be applied to all of two sides and the upper end portion of the circuit block 100.

Referring to FIG. 4E, the display drive chip 1100e may include the circuit block 100, the voltage generating units 210 and 220, a plurality of pads P1, P2, P3, and P4, and the bump B1. In addition, the storage capacitors Cst1 and Cst2 may be installed outside the display drive chip 1100e. The first pad P1 and the second pad P2 may be output pads that are positioned on an input stage of the display drive chip 1100e and may be connected to the first and second voltage generating units 210 and 220 and the storage capacitors Cst1 and Cst2. The bump B1 may be positioned inside the circuit block 100 in a layout and may be connected to wiring of the power voltage VDD positioned in a central portion of the circuit block 100 through internal wiring. The third pad P3 and the fourth P4 may each be a dummy pad positioned on an output stage and may be connected to the wiring of the power voltage VDD positioned on an upper end portion of the circuit block 100 through internal wiring. The pads P1, P2, P3, and P4 and the bump B1 may be electrically connected to each other through external wirings so as to reduce line resistance of wiring of the power voltage VDD applied to the circuit block 100.

Thus far, a pattern of external wiring of a display drive chip has been described according to the various embodiments of the inventive concept. However, the inventive concept is not limited thereto. With reference to the above-described embodiments of the inventive concept, the number of pads and bumps or the pattern of the external wiring may be changed in various ways.

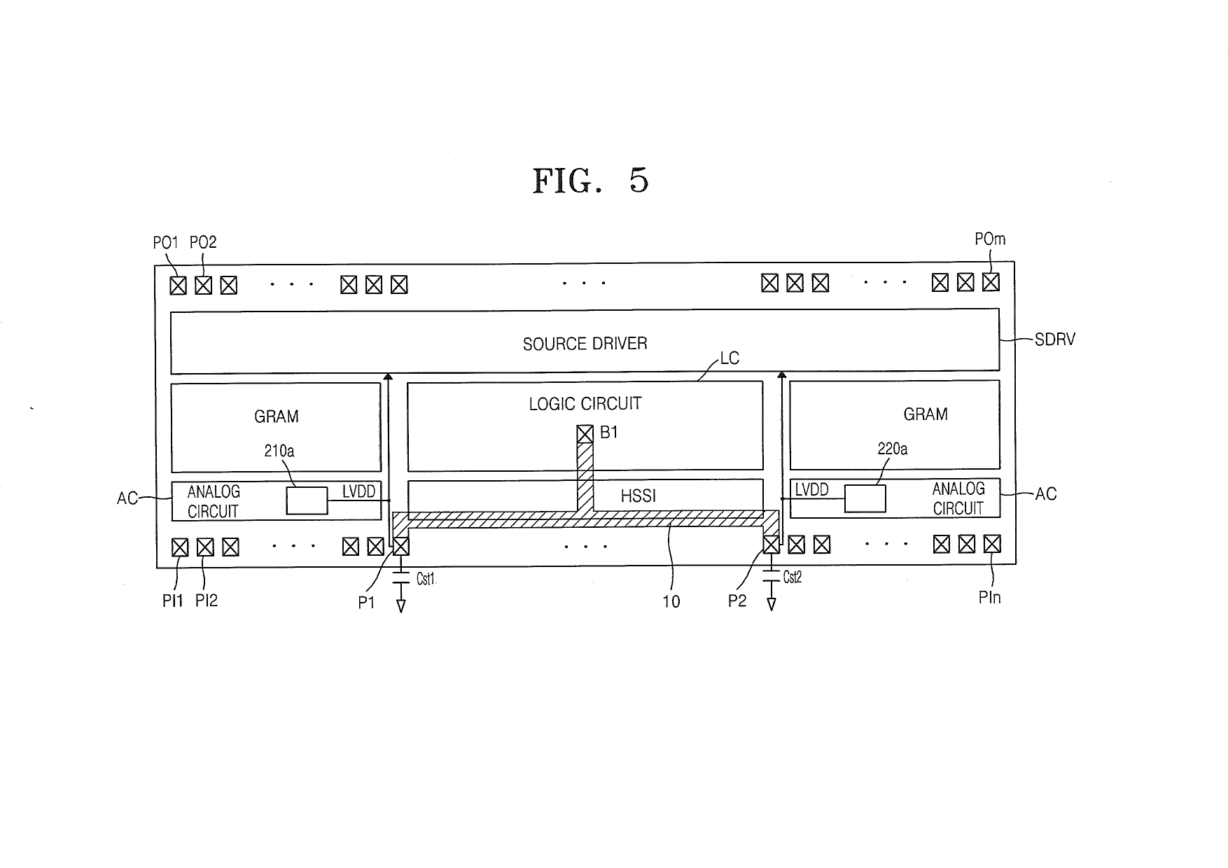

FIG. 5 is a floor plan view of the display drive chip of FIG. 1, according to an embodiment of the inventive concept.

The display drive chip of FIG. 5 may be a display drive chip installed in a mobile device (hereinafter, the display drive chip of FIG. 5 will be referred to as a mobile drive chip).

Referring to FIG. 5, the mobile drive chip has a structure having a short vertical length, that is, a short height, and a relatively long horizontal length, that is, a large width. Input and output pads PI1 to PIn and PO1 to POm may be positioned on a lower end portion and a upper end portion based on the floor plan view, that is, an input stage and an output stage, respectively. A high speed interface circuit HSSI may be positioned in an internal central portion of the floor plan view and analog circuits AC may be positioned at sides of the high speed interface circuit HSSI. The graphic RAM GRAM and a logic circuit LC may be positioned in a central portion of the high speed interface circuit HSSI and a source driver SDRV may be position on an internal upper end portion of the high speed interface circuit HSSI. A gate driver may be further positioned at right and left portions of the mobile drive chip. External components such as the storage capacitors Cst1 and Cst2 or the like may be connected to an internal circuit through the input pads PI1 to PIn.

The high speed interface circuit HSSI receives an image signal and input signals from a host. In addition, the high speed interface circuit HSSI transmits the received image signal to the graphic RAM GRAM and transmits the received input signals to the logic circuit LC. Thus, the high speed interface circuit HSSI may be positioned in a central portion (along the width) at a lower end portion of the floor plan view in consideration of transmission efficiency.

The analog circuits AC receive a voltage from an external source and generates a power voltage used in the logic circuit LC, the graphic RAM GRAM, the source driver SDRV, and a gate driver. In order to generate power voltages used by respective circuits, the display drive chip 1100 may include various power supply circuits such as a voltage regulator, a direct current (DC)/DC converter, or the like. In addition, in order to stably apply the power voltage, output of each circuit may be connected to the storage capacitors Cst1 and Cst2 installed outside the display drive chip 1100 through an output pad positioned on an input stage. Thus, the analog circuits AC may be positioned along the vertical sides of the lower end portion of the floor plan view.

The source driver SDRV receives an image signal and a control signal from the graphic RAM GRAM and the logic circuit LC, respectively and generates a driving signal applied to a data line of a display panel. The source driver SDRV may output the driving signal to the data line of the display panel through the output pads PO1 to POm. Thus, the source driver SDRV may be positioned in an upper portion (in the vertical direction) of the floor plan view.

The logic circuit LC receives input signals from the high speed interface circuit HSSI, generates a control signal for driving the display panel, based on the input signals, and transmits the control signal to the graphic RAM GRAM and the source driver SDRV. Thus, the logic circuit LC may be positioned in a central portion of the floor plan view in consideration of transmission efficiency.

The graphic RAM GRAM receives the control signal from the logic circuit LC and outputs an image signal to the source driver SDRV. Thus, on the floor plan view, graphic RAMs GRAMs may be positioned below the source driver SDRV and next to sides of the logic circuit LC.

Referring to FIGS. 1 and 5, the circuit block 100 of FIG. 1 may be the logic circuit LC of FIG. 3 and the first and second voltage generating units 210 and 220 of FIG. 1 may be one of various voltage applying circuits included in the analog circuits ACs of FIG. 5. The first and second voltage generating units 210 and 220 may be positioned at sides of the logic circuit LC, and the first and second pads P1 and P2 adjacent to the first and second voltage generating units 210 and 220 and the bump B1 positioned in the logic circuit LC may be electrically connected to each other through external wiring to reduce line resistance of wiring of the logic power voltage LVDD that is power voltage of the logic circuit LC without increasing a layout area of the logic circuit LC. In this case, the bump B1 may be an island bump that is positioned in a mobile drive chip or in a central portion of the mobile drive chip in order to prevent the mobile drive chip having a long horizontal length from being bent.

As described above, the first and second voltage generating units 210 and 220 may be positioned at sides of the logic circuit LC, and the first and second voltage generating units 210 and 220 and the pads P1 and P2 and the bump B1, which are connected to wiring of the logic power voltage LVDD of the logic circuit LC, may be connected to each other through the external wiring 10 so as to reduce a drop in line voltage (IR drop) of the logic power voltage LVDD and to apply the logic power voltage LVDD with a constant voltage level to an entire region of the logic circuit LC. In addition, the storage capacitors Cst1 and Cst2 that are connected to each other through the first and second pads P1 and P2 are charged with the logic power voltage LVDD and then when a large amount of current is temporarily consumed in the logic circuit LC, the storage capacitors Cst1 and Cst2 supply current to the logic power voltage LVDD. Thus, a voltage drop of the logic power voltage LVDD may be reduced.

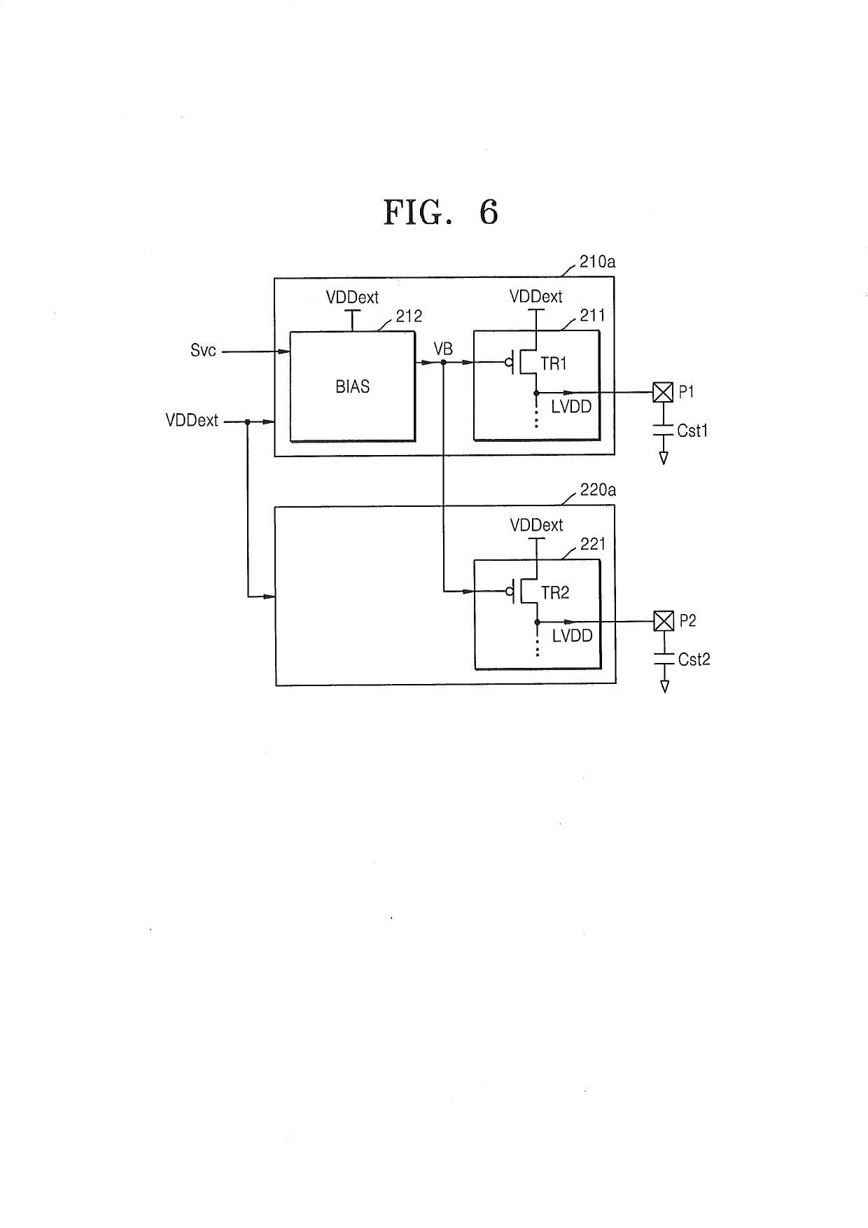

FIG. 6 is a block diagram of first and second voltage generating units 210a and 220a of the display drive chip of FIG. 5, according to an embodiment of the inventive concept. For convenience of description, the pads P1 and P2 and the storage capacitors Cst1 and Cst2 are illustrated together.

Referring to FIG. 6, the first voltage generating unit 210a and the second voltage generating unit 220a receive an external voltage VDDext and generate and output the logic power voltage LVDD. The first voltage generating unit 210a may include a bias voltage generating unit 212 and a first output stage 211. The bias voltage generating unit 212 may receive a voltage control signal Svc from an external source and may generate a bias voltage VB. The voltage control signal Svc may be set by a user such that the logic power voltage LVDD may be generated having a desired level. The first output stage 211 receives the bias voltage VB and outputs the logic power voltage LVDD through a CMOS transistor TR1.

The second voltage generating unit 220a may include a second output stage 221. The second output stage 221 includes a CMOS transistor TR2. The second output stage 221 receives the bias voltage VB and outputs the logic power voltage LVDD, like the first output stage 211. The bias voltage VB may be applied from the bias voltage generating unit 212 included in the first voltage generating unit 210a. However, the inventive concept is not limited thereto. That is, the second voltage generating unit 220a may include a bias voltage generating unit that is separate from the first voltage generating unit 210a.

The first voltage generating unit 210a and the second voltage generating unit 220a receive the external voltage VDDext and output the logic power voltage LVDD. Since a voltage level of the logic power voltage LVDD used by the logic circuit LC is lower than the external voltage VDDext, the logic power voltage LVDD may be generated by the first voltage generating unit 210a and the second voltage generating unit 220a to have a higher voltage level than a voltage level used by the logic circuit LC in consideration of a voltage drop.

The first voltage generating unit 210a and the second voltage generating unit 220a may be connected to the storage capacitors Cst1 and Cst2 installed outside a display drive chip through the pads P1 and P2. As described with reference to FIG. 4A, the storage capacitors Cst1 and Cst2 are charged with the logic power voltage LVDD and then the storage capacitors Cst1 and Cst2 can supply current to the logic circuit LC. Thus, even if a large amount of current is temporarily drawn in the logic circuit LC, a voltage drop of the logic power voltage LVDD may be reduced.

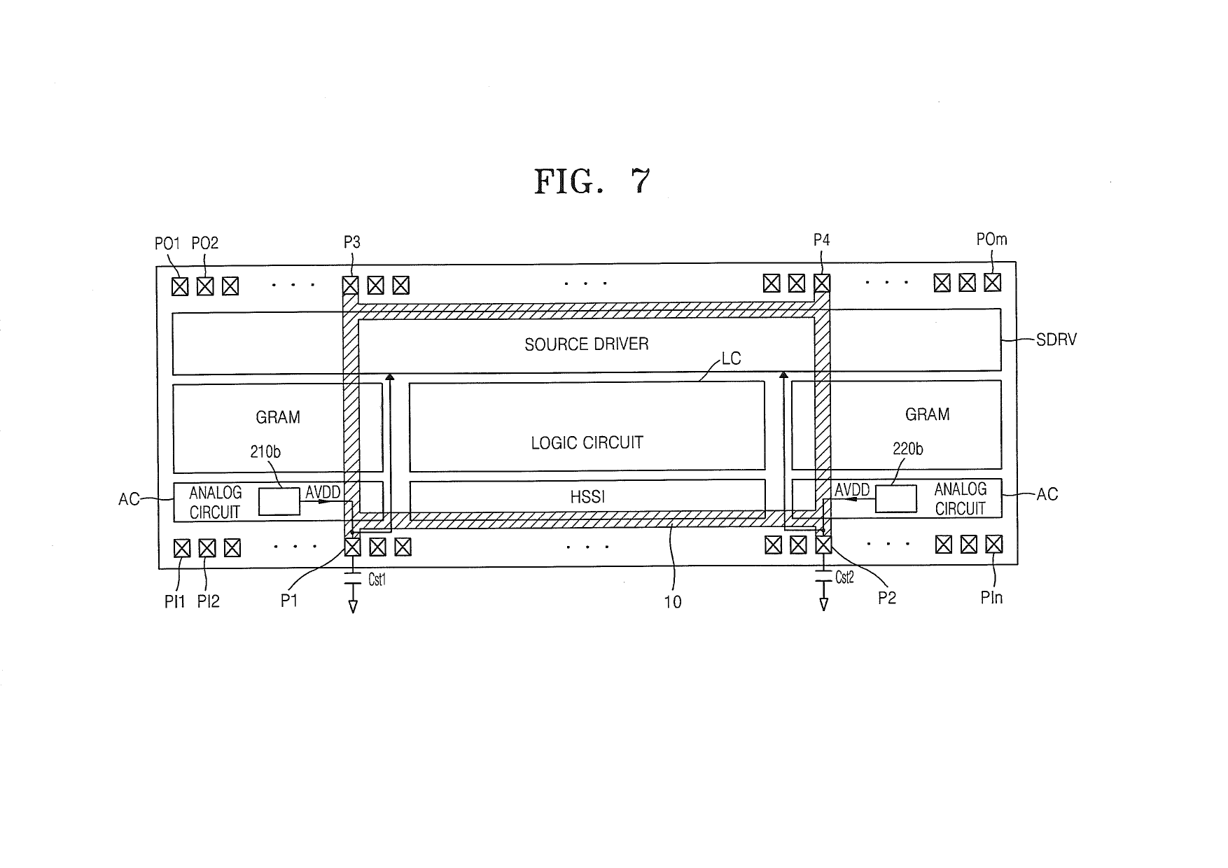

FIG. 7 is a floor plan view of the display drive chip of FIG. 1, according to another embodiment of the inventive concept.

A schematic floor plan of the display drive chip of FIG. 7 is analogous to that of FIG. 5. The circuit block 100 of FIG. 1 may be the source driver SDRV of FIG. 7, and a first voltage generating unit 210b and a second voltage generating unit 220b may be one of power supply circuits included in the analog circuits ACs. The first voltage generating unit 210b and the second voltage generating unit 220b may be positioned at sides of a lower end portion of the floor plan view, respectively. The power voltage VDD may be analog power voltage AVDD having a voltage level that is used by the source driver SDRV.

The source driver SDRV operates using the analog power voltage AVDD generated by the first and second voltage generating units 210b and 220b. The source driver SDRV is positioned on an upper end portion of the floor plan view, whereas the first and second voltage generating units 210b and 220b is positioned on a lower end portion of the display drive chip. Thus, the length of wiring between the first and second voltage generating units 210b and 220b and the source driver SDRV is relatively long. In addition, since the source driver SDRV drives a data line of a display panel, a large amount of current is consumed in the source driver SDRV. Thus, as appreciated by the present inventors, if the width of the wiring of the analog power voltage AVDD is not large, a drop in line voltage (IR drop), due to current flowing through wiring and line resistance of the wiring, may be increased. In addition, since the source driver SDRV has a long horizontal length, if width of wiring of the analog power voltage AVDD is not large enough in the source driver SDRV, voltage levels of the analog power voltage AVDD may be different at a right side, a left side, and a central portion of the source driver SDRV due to a drop in line voltage (IR drop).

In order to apply the analog power voltage AVDD at a constant voltage level to an entire region of the source driver SDRV, the first voltage generating unit 210b and the second voltage generating unit 220b may be positioned at sides of the mobile drive chip. In addition, the pads P1, P2, P3, and P4 may be electrically connected through the external wiring 10 so as to minimize line resistance of wiring the analog power voltage AVDD.

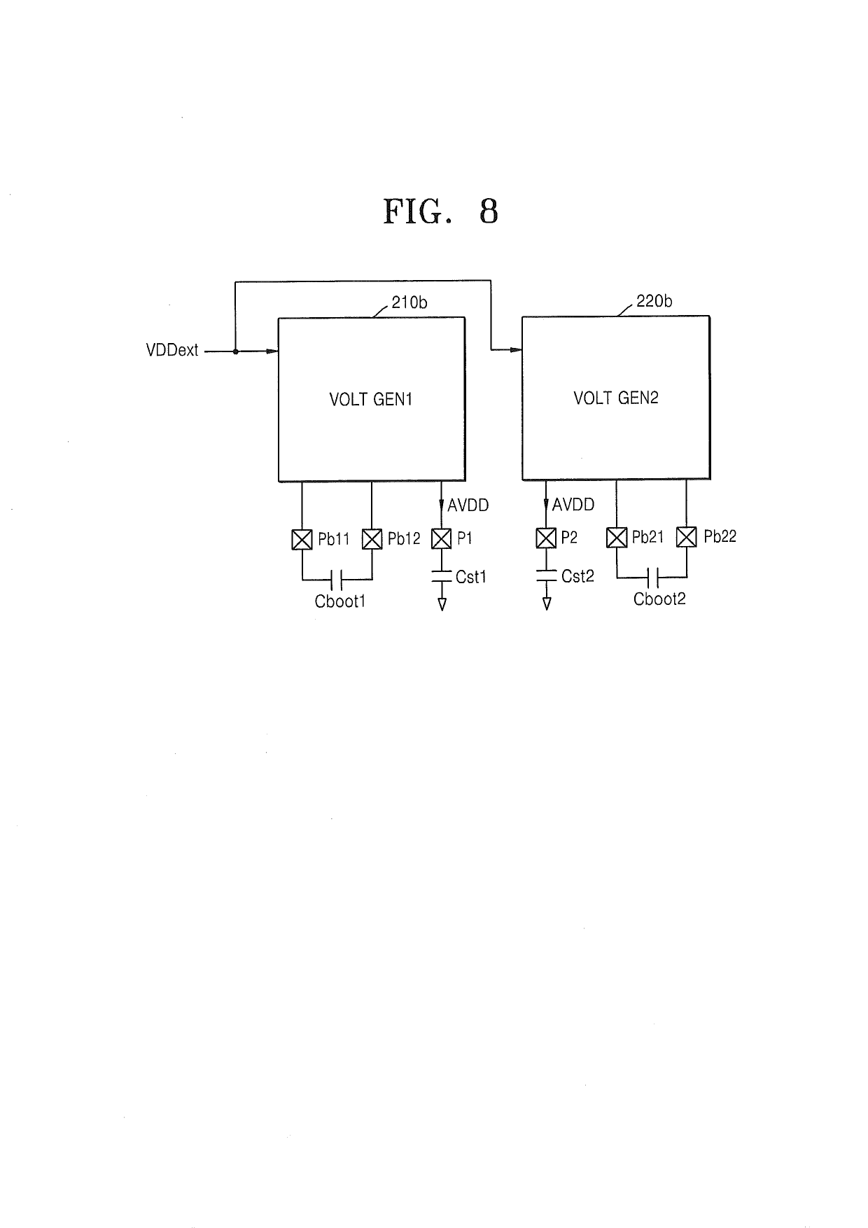

FIG. 8 is a block diagram of first and second voltage generating units 210b and 220b of the display drive chip of FIG. 7, according to another embodiment of the inventive concept. For convenience of description, the pads P1, P2, Pb11, Pb12, Pb21, and Pb22 and the storage capacitors Cst1, Cst2, Cboot1, and Cboot2 installed outside the display drive chip are illustrated together.

Referring to FIG. 8, the first and second voltage generating units 210b and 220b receive the external voltage VDDext and generate and output the analog power voltage AVDD that is power voltage of the source driver SDRV of FIG. 7. The first voltage generating unit 210b and the second voltage generating unit 220b may each include a booster circuit. The source driver SDRV may require about 5 V as the analog power voltage AVDD. In this regard, the external voltage VDDext applied from an external source may have a lower voltage level than the analog power voltage AVDD. Thus, the analog power voltage AVDD may be generated by increasing the external voltage VDDext. The booster circuit may include a boosting capacitor for increasing an applied voltage. Thus, a first boosting capacitor Cboot1 and a second boosting capacitor Cboot2 may be respectively connected to booster circuits through the pads Pb11, Pb12, Pb21, and Pb22, as shown in FIG. 8. In addition, in order to maintain a voltage level of the analog power voltage AVDD that is increased and output, the booster circuits may be connected to the storage capacitors Cst1 and Cst2 through the pads P1 and P2. A booster circuit would be understood by one of ordinary skill in the art to which the inventive concept pertains and thus a detailed description thereof will be omitted here.

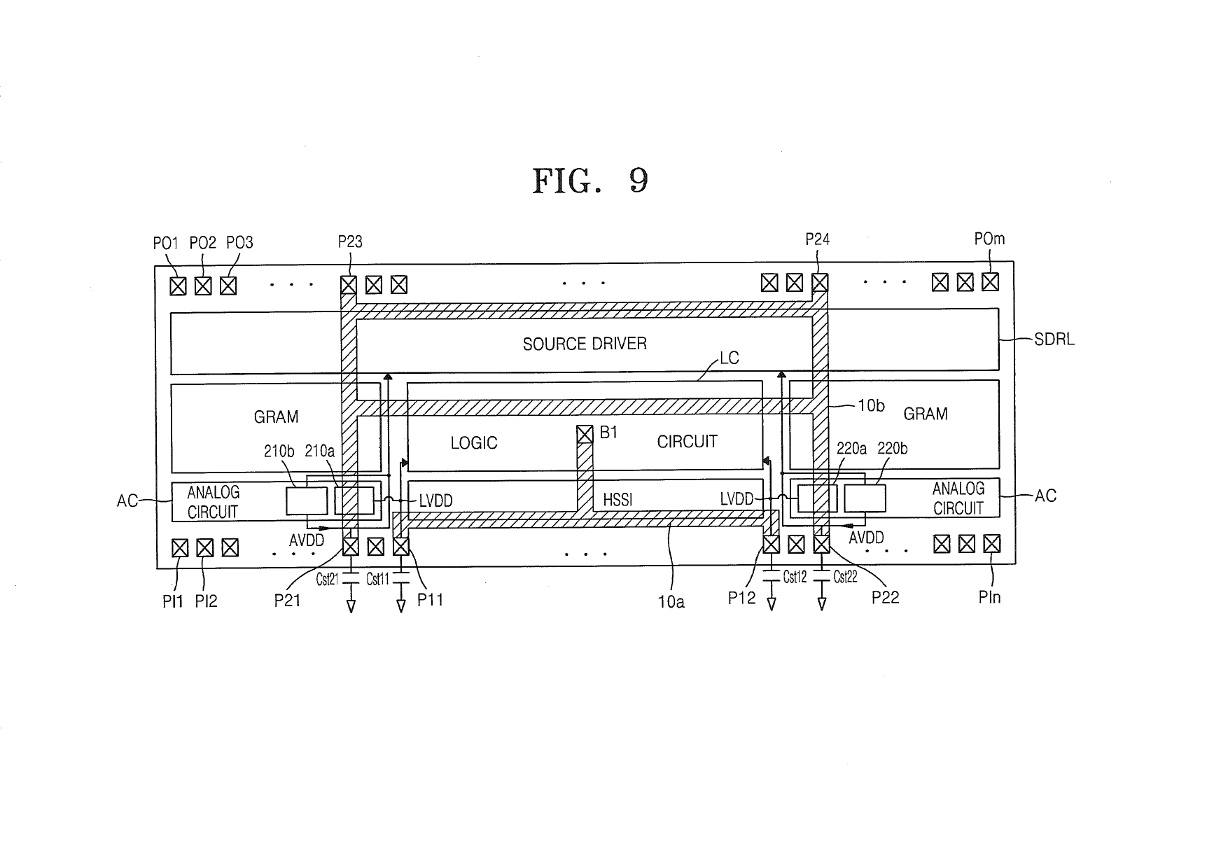

FIG. 9 is a floor plan view of the display drive chip of FIG. 1, according to another embodiment of the inventive concept. The display drive chip of FIG. 1 is a mobile drive chip and a schematic floor plan view thereof is the same as in FIG. 5.

Referring to FIG. 9, the first and second voltage generating units 210a and 220a for generating the power voltage VDD of the logic circuit LC and the first and second voltage generating units 210b and 220b for generating the analog power voltage AVDD of the source driver SDRV are positioned on lower end portions of the floor plan view. In order to reduce line resistance of wiring of the logic power voltage LVDD and the analog power voltage AVDD that are respectively applied to the logic circuit LC and the source driver SDRV, the pads P11, P12, P21, P22, P23, and P24 and the bump B1 are connected to each other through external wirings. A detailed description of a connection relationship between the pads through external wirings is the same as the detailed description with reference to FIGS, 5 and 7, and thus repetition thereof is omitted here.

As shown in FIG, 9, if external wiring 10a of the logic power voltage LVDD and external wiring 10b of the analog power voltage AVDD do not cross each other, both external wiring 10a and external wiring 10b are formed on the outside of the display drive chip. The pads P11, P12 and the bump B1 for the logic power voltage LVDD may be connected to each other through the external wiring 10a and the pads P21, P12, P23 and P24 for the analog power voltage AVDD may be connected to each other through the external wiring 10b. Thus, resistance of wirings of the logic power voltage LVDD of the logic circuit LC and the analog power voltage AVDD of the source driver SDRV may be reduced, thereby reducing a drop in line voltage (IR drop).

Thus far, a layout of a floor plan view of a display drive chip and the first and second voltage generating units 210 and 220 have been described with regard to exemplary embodiments of the inventive concept with reference to FIGS. 5 through 9. However, the embodiments of the inventive concept are not limited thereto and changes may be made therein without departing from the spirit and scope of the inventive concept.

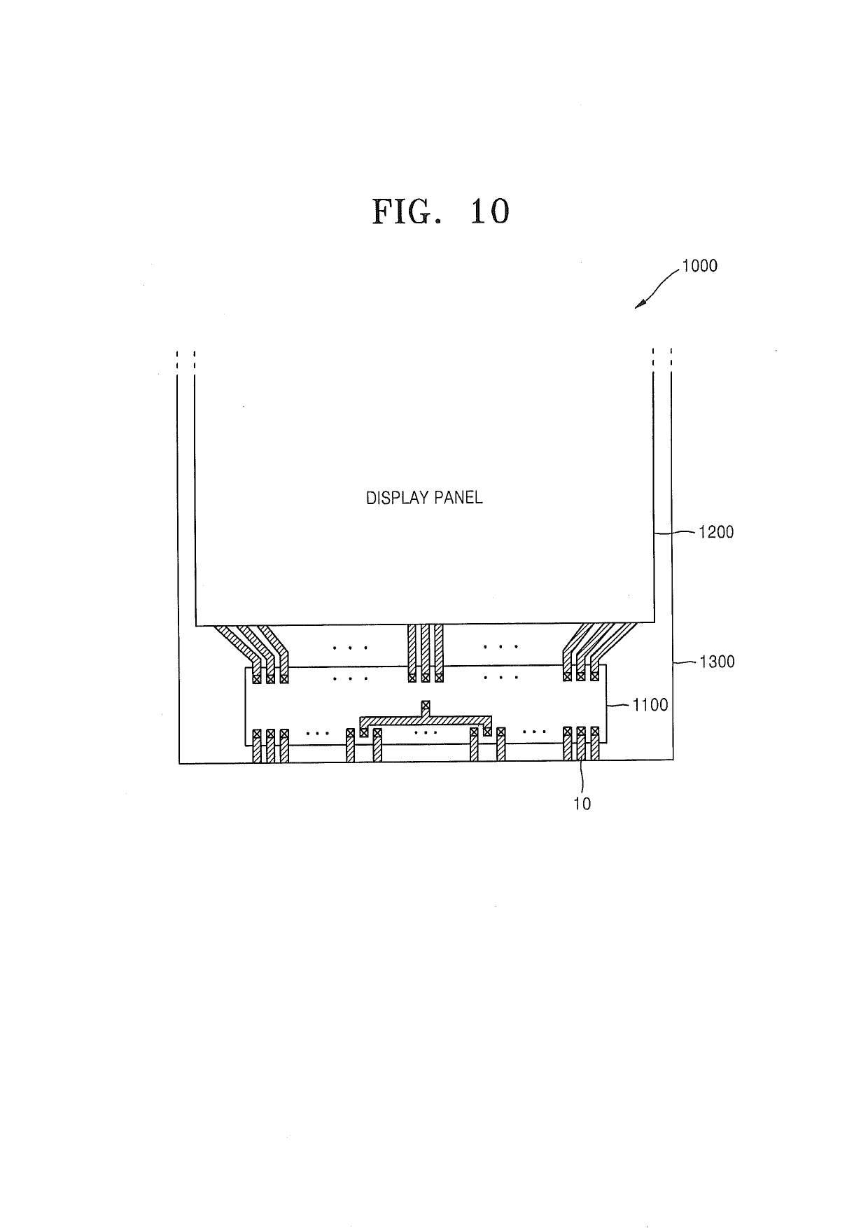

FIG. 10 is a diagram for describing a display device 1000 using a chip on glass (COG) according to an embodiment of the inventive concept.

Referring to FIG. 10, the display device 1000 may include a display panel 1200, the display drive chip 1100, and a glass substrate 1300.

The display panel 1200 receives a driving signal from the display drive chip 1100 and displays an image. The display panel 1200 may be a liquid crystal display (LCD) panel or a light emitting diode (LED) panel but is not limited thereto. Alternatively, the display panel 1200 may be various other types of panels.

The display drive chip 1100 may be the display drive chip 1100 of FIG. 1. The display drive chip 1100 may receive an input signal and an image signal through input pads positioned on a lower end portion of the display drive chip 1100, may generate a driving signal based on the input signal and the image signal, and may output the driving signal to the display panel 1200 through output pads positioned on an upper end portion of the display drive chip 1100. The display drive chip 1100 may be mounted on the glass substrate 1300. Likewise, a method of mounting the display drive chip 1100 on the glass substrate 1300 is referred to as a COG method.

In the display device using the COG method, input pads of the display drive chip 1100 and external terminals of the display device 1000, and output pads and the display panel 1200 may be electrically connected to each other through external wirings 10 formed on the glass substrate 1300. According to the present embodiment, the external wiring 10 of FIG. 1 may also be formed on the glass substrate 1300. In this case, the external wiring 10 formed on the glass substrate 1300 may be a transparent electrode such as an indium tin oxide (ITO) electrode.

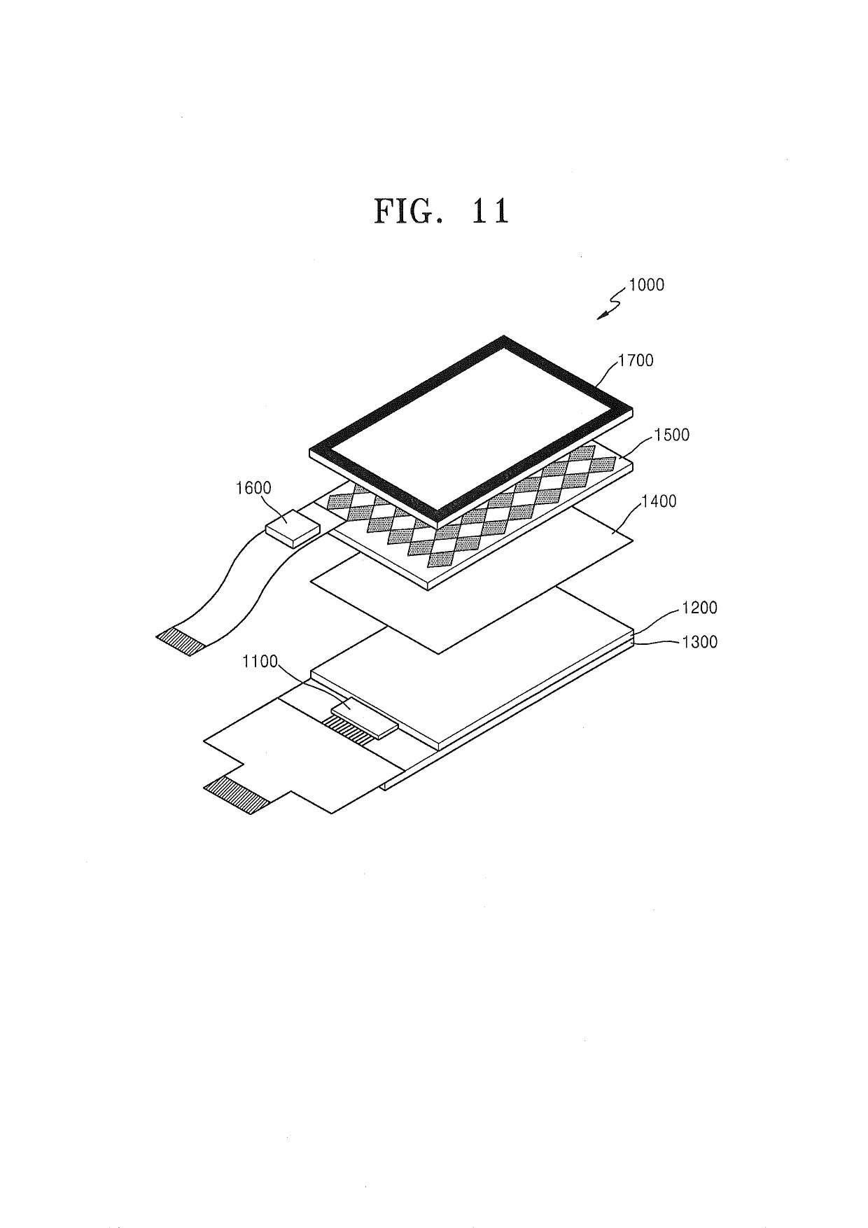

FIG. 11 is a perspective view of a display device 1000 according to an embodiment of the inventive concept.

The display device 1000 may include the glass substrate 1300, the display drive chip 1100, the display panel 1200, a polarization plate 1400, and a window glass 1700.

In general, the window glass 1700 is formed of a material such as acrylic, tempered glass, or the like so as to prevent the window glass 1700 from being scratched due to an external shock or repeated touch. The polarization plate 1400 may be used to improve the optical properties of the display panel 1200. The display panel 1200 is formed by patterning a transparent electrode formed on the glass substrate 1300. The display drive chip 1100 may be installed on the glass substrate 1300 by using a COG type method. However, the display device 1000 of FIG. 11 is just an example. That is, the display device 1000 may be installed to be of various types, for example, a chip on film (COF), a chip on board (COB), or the like. The display drive chip 1100 may be the display drive chip 1100 of FIG. 1. Thus, pads may be electrically connected to each other through ITO wiring formed on the glass substrate 1300.

Recently, touch screen type products have been widely used in various fields and have replaced button-type products due to their spatial advantages. The most popular field is cell phones in which smart phones have become more proactive. In particular, it is well known that since the ease of use and size of cell phones are very important, a touch phone method having no key or having minimum keys is attracting considerable attention. Thus, the display device 1000 may further include a touch panel 1500 and a touch controller 1600. The touch panel 1500 may be formed by patterning a transparent electrode such as an ITO electrode formed on a glass substrate or a polyethylene terephthlate (PET) film. The touch controller 1600 detects a touch on the touch panel 1500, calculates touch coordinates or the like, and transmits the calculating result to a host (not shown). The touch controller 1600 and the display drive chip 1100 may be integrated on a single semiconductor chip.

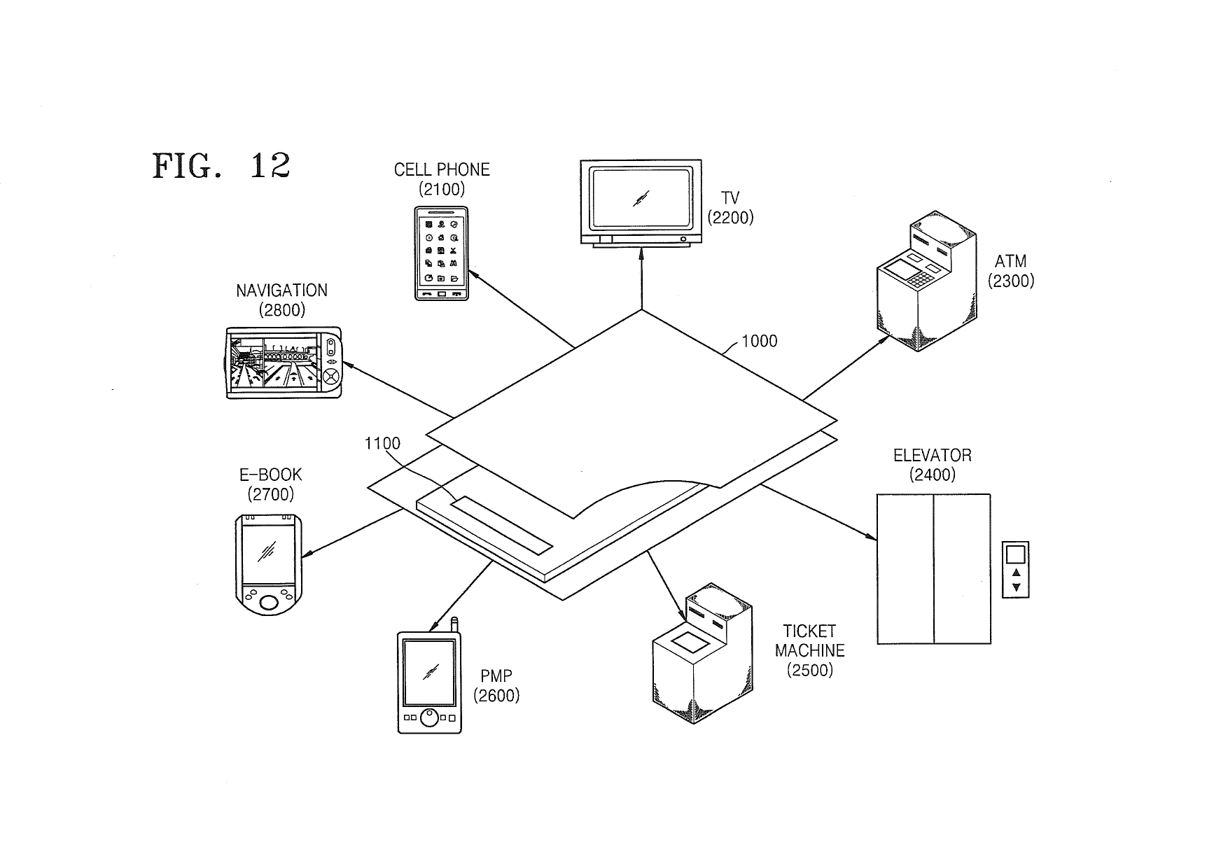

FIG. 12 shows applications of various electronic products including the display device 1000 installed thereon, according to an embodiment of the inventive concept.

According to the present embodiment, the display device 1000 may be used in various electronic products. The display device 1000 may be widely used in a television (TV) 2200, an automated teller machine (ATM) 2300 for automatic deposit and withdrawal instead of a bank, an elevator 2400, a ticket automated dispenser 2500 in a subway station or the like, a portable multimedia player (PMP) 2600, an e-book 2700, a navigation device 2800, or the like, as well as in a cell phone 2100.

While the inventive concept has been particularly shown and described with reference to exemplary embodiments thereof, it will be understood that various changes in form and details may be made therein without departing from the spirit and scope of the following claims.

What is claimed:

1. A display drive chip comprising:
a first voltage generating unit outputting a power voltage and a second voltage generating unit outputting the power voltage;
a circuit block that receives the power voltage; and
a plurality of pads connected to internal wiring of the power voltage,
wherein the display drive chip has a layout structure in which at least two pads from among the plurality of pads are connected to the first voltage generating unit and the second voltage generating unit, respectively, and the plurality of pads are connected to each other through external wiring.

2. The display drive chip of claim 1, wherein the at least two pads are spaced apart from each other by a predetermined interval in a layout.

3. The display drive chip of claim 1, further comprising at least one bump,
wherein the at least one bump is connected to the plurality of pads through external wiring and has a layout structure positioned in the circuit block.

4. The display drive chip of claim 1, wherein at least one pad from among the plurality of pads is positioned on an output stage.

5. The display drive chip of claim 1, wherein the at least two pads are connected to capacitors, respectively.

6. The display drive chip of claim 1, wherein the first voltage generating unit and the second voltage generating unit receive a voltage from an external source and generate the power voltage.

7. The display drive chip of claim 1, wherein the first voltage generating unit comprises a bias generating unit and a first output stage, and
wherein the second voltage generating unit comprises a second output stage, and
wherein a control voltage output from the bias generating unit is applied to the first output stage and the second output stage.

8. The display drive chip of claim 1, wherein the circuit block has a layout structure in which a horizontal length is greater than a vertical length.

9. The display drive chip of claim 1, wherein the display drive chip is a mobile display drive chip in mobile device, and
wherein the circuit block is one of a plurality of driving modules in the display drive chip.

10. The display drive chip of claim 1, wherein the display drive chip is mounted on a glass substrate of a display device, and
wherein the external wiring is wiring formed on the glass substrate.

11. The display drive chip of claim 10, wherein the wiring formed on the glass substrate is indium tin oxide (ITO) wiring.

12. A display device comprising:
a display panel;
a display drive chip for driving the display panel; and
a connection portion for connecting the display panel and the display drive chip to each other,
wherein the display drive chip comprises a first voltage generating unit outputting a power voltage and a second voltage generating unit outputting the power voltage;
a circuit block that receives the power voltage;
a plurality of pads connected to internal wiring of the power voltage; and at least one bump, and
wherein at least one pad from among the plurality of pads is internally connected to the wiring of the power voltage and is externally connected to each other through wiring formed on the connection portion.

13. The display device of claim 12, wherein the connection portion is a glass substrate, and
wherein the connection portion is a glass substrate and the display drive chip is mounted on the glass substrate by using a chip on glass (COG) method.

14. A display device comprising:
a display device substrate;
a display drive chip comprising a plurality of internally spaced apart voltage generating units providing respective power voltages configured for operation of the display drive chip, wherein the respective power voltages are distributed within the display drive chip via internal wiring inside the display drive chip;
a plurality of pads, on an exterior of the display drive chip, and coupled to the internal wiring; and
external wiring outside the display drive chip, coupled to the plurality of pads.

15. The display device of claim 14 wherein the plurality of pads comprises a plurality of input pads spaced apart along a first edge of the display drive chip.

16. The display device of claim 15 further comprising:
a bump, on the display drive chip spaced apart from the plurality of input pads, configured to electrically connect the internal wiring within a logic circuit region of the display drive chip to the external wiring, wherein the logic circuit region is located in a central region of the display drive chip.

17. The display device of claim 16 wherein the external wiring provides a lower resistance path for the respective power voltages to the logic circuit region.

18. The display device of claim 16 wherein the bump comprises a plurality of spaced apart bumps on the display drive chip, each configured to electrically connect the internal wiring within a respective region of the display drive chip to the external wiring.

19. The display device of claim 14 wherein the plurality of pads comprise input pads along a first edge of the display drive chip, the display device further comprising:
an internal source driver circuit, inside the display drive chip, configured to drive signals to the display device; and
a plurality of output pads, on the exterior of the display drive chip along a second edge of the display drive chip, and coupled to the internal wiring within the internal source driver circuit.

20. The display device of claim 19 further comprising:
a bump, on the display drive chip spaced apart from the plurality of output pads, configured to electrically connect the internal wiring within the internal source driver circuit of the display drive chip to the external wiring, wherein the internal source driver circuit is located directly adjacent to the plurality of output pads.
